(19) United States
(12) Patent Application Publication
(10) Pub. No.: US 2021/0233088 A1
(43) Pub. Date: Jul. 29, 2021

(54) SYSTEMS AND METHODS TO REDUCE FRAUD TRANSACTIONS USING TOKENIZATION

(71) Applicant: Mastercard International Incorporated, Purchase, NY (US)

(72) Inventors: Vipul Mehrotra, Sandila (IN); Jaipal Singh Kumawat, Sikar (IN); Gurpreet Atwal, Chesterfield, MO (US)

(73) Assignee: Mastercard International Incorporated, Purchase, NY (US)

(21) Appl. No.: 16/751,386

(22) Filed: Jan. 24, 2020

(51) Int. Cl. G06Q 20/42; G06Q 20/38; G06Q 20/32

(52) U.S. Cl. CPC G06Q 20/425; G06Q 20/3255; G06Q 20/385

(57) ABSTRACT

A token/alert service system has a database and server. The server is programed to receive a transaction message from a merchant. The message corresponds to a transaction associated with a payment card of a consumer. The server determines whether the message is an authorization request message and, based on the determination that the electronic transaction message is an authorization request message, extracts the primary account number from the message. The server transmits a transaction alert message to the consumer. The alert message includes a request that the consumer respond to the alert message approving or rejecting the transaction. The server receives a response from the consumer and, if the response approves the transaction, transmits a token request message to a card issuer of the payment card. The server generates a token, transmits the token to the merchant, and receives from the merchant, a second authorization request message using the token.

### FIELD OF THE DISCLOSURE

The field of the disclosure relates generally to electronic financial transactions and, more particularly, to systems and methods for notifying a consumer of a payment card transaction and tokenizing the primary account number of the payment card before processing the transaction.

### BACKGROUND OF THE DISCLOSURE

A typical consumer performs payment card transactions in several ways with varying purchase amounts and number of transactions in a given period. Within the payment card processing system, the consumer typically does not receive notification of a transaction until the transaction has been authorized or is cleared and the transaction is presented to the consumer on a billing statement. Thus, a consumer may not have the ability to prevent a transaction by a fraudster

In addition, as part of a purchase transaction, the payment card account number and other account information that is transmitted from the payment card to the payment terminal, is subsequently stored in a form that can be easily read by a fraudster that has gained access to the transaction system (e.g., a merchant's transaction database). Payment tokens, however, are surrogate values that may be used to replace a primary account number (PAN) of a payment card in the payment system. Such tokens provide increased protection against fraudulent use such as counterfeiting, account misuse, and other forms of fraud. The storage of a payment token in a merchant's transaction database can facilitate preventing fraudulent use of a consumer's payment card as a token in typically transactions specific and has no value to a fraudster.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computer-implemented method is provided. The method includes receiving an electronic transaction message from a merchant. The electronic transaction message corresponds to a transaction associated with a primary account number of a payment card belonging to a consumer. The method also includes determining whether the electronic transaction message is an authorization request message and, based on a determination that the electronic transaction message is an authorization request message, extracting the primary account number from the electronic transaction message. Furthermore, the method includes transmitting a transaction alert message to the consumer. The transaction alert message includes a request that the consumer respond to the transaction alert message approving or rejecting the transaction. The method includes receiving a response to the transaction alert message from the consumer and, if the response is approving the transaction, transmitting a token request message to a card issuer associated with the payment card. Moreover, the method includes generating a token for the primary account number, transmitting the token to the merchant, and receiving from the merchant, a second authorization request message for the transaction. The second authorization request message includes the token.

In another aspect, a token/alert service system is provided. The system includes a database and a server. The server includes a processor coupled to said database. The processor is programmed to receive an electronic transaction message from a merchant. The electronic transaction message corresponds to a transaction associated with a primary account number of a payment card belonging to a consumer. The processor is also programmed to determine whether the electronic transaction message is an authorization request message and, based on a determination that the electronic transaction message is an authorization request message, extract the primary account number from the electronic transaction message. Furthermore, the processor is programmed to transmit a transaction alert message to the consumer. The transaction alert message includes a request that the consumer respond to the transaction alert message approving or rejecting the transaction. Moreover, the processor is programmed to receive a response to the transaction alert message from the consumer and, if the response approves the transaction, transmit a token request message to a card issuer associated with the payment card. In addition, the processor is programmed to generate a token for the primary account number, transmit the token to the merchant, and receive from the merchant, a second authorization request message for the transaction. The second authorization request message includes the token.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party network system, including a token/alert service system, in accordance with one embodiment of the present disclosure;

FIG. 2 is a simplified block diagram of an example payment card network system, such as the network system shown in FIG. 1, including a plurality of computing devices and the token/alert service system shown in FIG. 1;

FIG. 3 is an example configuration of a user system for use in the network system shown in FIG. 1;

FIG. 4 is an example configuration of a server system for use in the network system shown in FIG. 1;

FIG. 5 is a flowchart illustrating an exemplary computer-implemented method for registering a consumer for the transaction alert service, in accordance with one embodiment of the present disclosure; and

FIGS. 6A and 6B cooperatively depict a flowchart illustrating an exemplary computer-implemented method for generating a transaction alert message and tokenizing a payment card transaction using the token/alert service system (shown in FIGS. 1 and 2), in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. It is contemplated that the invention has general application for alerting a consumer to transactions being performed using the consumer's payment card and, upon approval of the transaction by the consumer, tokenizing the primary account number before processing the transaction. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

As used herein, the terms “payment card,” “transaction card,” and “financial transaction card,” may include any suitable transaction card, such as a credit card, a debit card, a charge card, a membership card, a promotional card, an identification card, a prepaid card, a gift card, and/or any other card-type device that may hold payment account information. Each type of transaction card can be used as a method of payment for performing a transaction.

Furthermore, as used herein, the term “real-time” includes at least one of the times of occurrence of the associated events, the time of collection of data, the time to process the data, and the time of a system response to the events and the environment. For the activities and the events in the embodiments described herein as occurring in real-time, it should be assumed that they occur substantially instantaneously.

Embodiments of the present technology relate to systems, methods, and computer-readable media for providing alert notifications to consumers for selected account transactions, such as, debit transactions, and for generating a token for the primary account number associated with transactions. As such, the consumer is able to receive notification of a transaction before it is performed, select to approve or reject the transaction, and upon approval, perform the transactions with his or her payment card information being tokenized.

As will be appreciated, based upon the description herein, the technical improvement to the technological field of payment card transactions, as described herein, is a technical solution to a technical deficiency or problem that is itself rooted in computer technology (i.e., the problem itself derives from the use of computer technology). More specifically, the technical problems of payment card transactions are the result of an implementation and use of computers in financial institution processing systems and methods intended to keep the financial account data private and secured. The present disclosure improves upon the conventional methods and systems in the manners described herein. Thus, the inefficiencies or technical problems created by conventional financial institution data processing systems and methods are solved by the methods and systems described and particularly claimed.

### Payment Network System

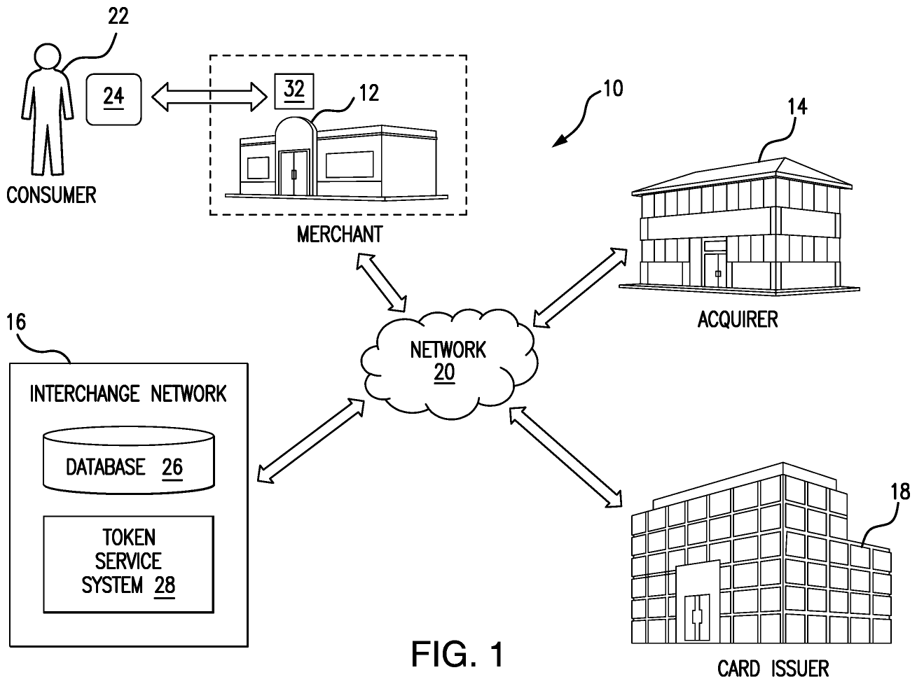

FIG. 1 is a block diagram of an example multi-party payment card network system 10 having a token/alert service system (TASS) 28, in accordance with the present invention. The payment card network system 10 facilitates providing interchange network services offered by an interchange network 16. In addition, the payment card network system 10 enables payment card transactions (e.g., contact and contactless) in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc. As used herein, the term “interchange network” includes an electronic network that exchanges data relating to the value of card sales and credits among the card issuers 18 and the acquirers 14 (e.g., networks maintained, for example, by Mastercard®). (Mastercard is a registered trademark of Mastercard International Incorporated.)

In the example embodiment, the payment card network system 10 generally includes the merchants 12, the acquirers 14, the interchange network 16, and the card issuers 18 coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the card issuers 18. In some embodiments, the network 20 may include more than one type of network, such as a private payment transaction network provided by the interchange network 16 to the acquirers 14 and/or the card issuers 18, and, separately, the public Internet, which may facilitate communication between the merchants 12, the interchange network 16, the acquirers 14, and consumers 22, etc.

Embodiments described herein may relate to a transaction card system, such as a credit card payment system using the Mastercard interchange network. The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by a card issuer (e.g., the card issuer 18), purchase data representing a purchase made by the consumer 22, including a type of merchant, amount of purchase, date of purchase, and other data, which may be transmitted between any parties of multi-party payment card network system 10.

In a transaction card system as described herein, a financial institution called the “card issuer” issues a payment card, such as a payment card 24, to the cardholder or consumer 22, who uses the payment card 24 to tender payment for a purchase from the merchant 12. In the example embodiment, the merchant 12 is typically associated with products, for example, and without limitation, goods and/or services, that are offered for sale and are sold to the consumer 22. The merchant 12 includes, for example, a physical location and/or a virtual location. A physical location includes, for example, a brick-and-mortar store, etc., and a virtual location includes, for example, an Internet-based store-front.

To accept payment with the payment card 24, the merchant 12 must normally establish an account with a financial institution that is part of the payment card network system 10. This financial institution is usually called the “merchant bank,” the “acquiring bank,” or the “acquirer” (e.g., the acquirer 14). When the consumer 22 provides payment for a purchase with the payment card 24, the merchant 12 requests authorization from the acquirer 14 for the purchase amount. The request may be performed over the telephone but is usually performed using a point-of-sale (POS) terminal, for example, a POS terminal 32, that connects to the payment card 24. The POS terminal 32 reads the consumer's payment account information, such as a primary account number (PAN), expiration date, etc. from a magnetic stripe and/or an integrated circuit chip on the payment card 24 and communicates electronically with the transaction processing computers of the acquirer 14. Alternatively, the acquirer 14 may authorize a third party to perform transaction processing on its behalf. In this case, the POS terminal 32 will be configured to communicate with the third party. Such a third party is usually called a “merchant processor,” an “acquiring processor,” or a “third party processor.”

In the exemplary embodiment, computers of the acquirer 14 or merchant processor communicate with the interchange network 16 to relay authorization requests and response messages between the merchant 12 (e.g., via the POS terminal 32) and the card issuer 18. The interchange network 16 analyzes the incoming authorization requests to determine whether to send them to the TASS 28 or directly to the card issuer 18.

Typically, notifications of transactions being performed using the payment card 24 are not presented to the consumer 22 until after the transaction has been authorized by the card issuer 18. As such, if the consumer 22 did not perform the transaction or otherwise did not approve of the transaction being performed, the consumer 22 alerts the card issuer 18 that the transaction is likely fraudulent. This can lead to lost funds for the merchant, the card issuer, and/or the consumer. In addition, transactions initiated by the payment card 24 at the POS terminal 32 do not include tokenized account data (such data including, for example, the PAN and the expiration date). Rather, the actual PAN and expiration date are read by the POS terminal 32 directly from the payment card 24. In typical transaction processing, after a purchase has been completed, during and/or after a transaction clearing process, additional data, such as a time of purchase, a merchant name, a type of merchant, purchase information, consumer account information, a type of transaction, information regarding the purchased item and/or service, and/or other suitable information, is associated with a transaction and transmitted between the parties to the transaction as transaction data, and may be stored by any of the parties to the transaction, for ex ample, in a transaction database. As a result, it is possible that merchant data breaches, compromised transaction storage systems, and the like can cause the actual PAN and expiration date of a payment card to be exposed to fraudsters. A stolen PAN and associated expiration date can be used by fraudsters to perform fraudulent transactions using the compromised card data, such as in mag-swipe transactions, online or electronic commerce, card-on-file transactions, mail order/telephone order (MOTO) channels, and the like.

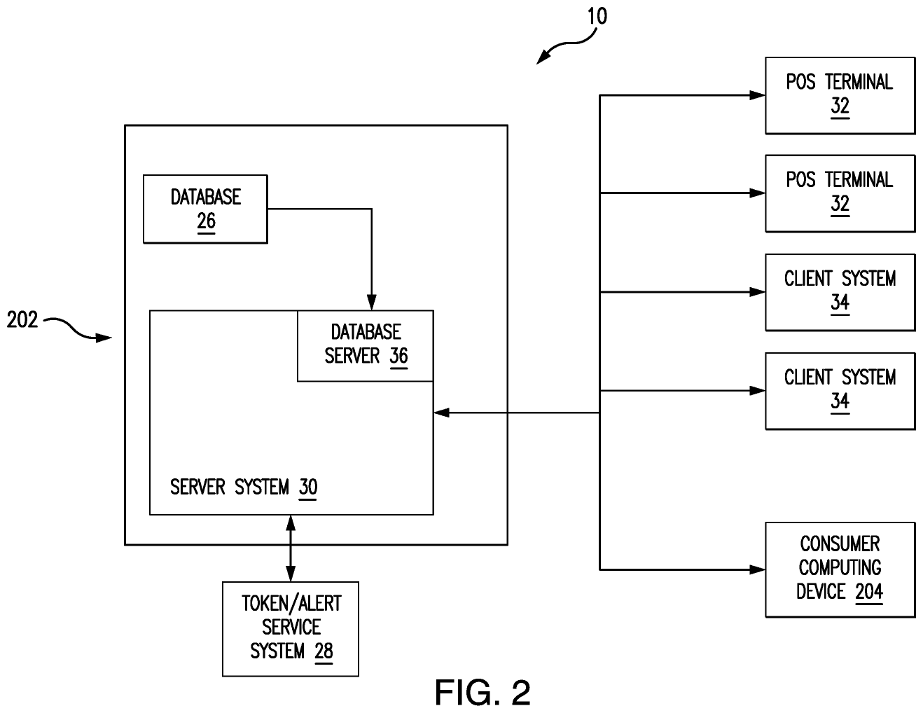

Thus, in the exemplary embodiment, the interchange network 16 includes the TASS 28, which is configured to generate or assign one or more payment tokens to respective payment accounts that are to be tokenized and to generate and transmit a transaction alert message to the consumer 22. The transaction alert message allows the consumer 22 to approve or reject the transaction prior to it being passed to the card issuer 18 for processing. Tokenization can be initiated, for example, at the POS terminal 32, at a consumer computing device 204 (shown in FIG. 2), an automated teller machine (ATM), and/or any other transaction processing device.

In one embodiment, during a tokenization operation initiated, for example, at the POS terminal 32, the TASS 28 generates and transmits a transaction alert message to the consumer 22. The transaction alert message can include, for example, a push notification to a mobile device, an SMS or “text” message, an email message, a telephone call, etc. requiring a response by the consumer 22. Upon receipt of an approval response from the consumer 22, the TASS 28 transmits the PAN to the card issuer 18 along with a request message to tokenize the PAN. In some embodiments, the card issuer 18 may evaluate risk associated with the token request message and perform other assessments and/or processing before approving and transmitting the token request message to the TASS 28. The TASS 28 generates or assigns a payment token to the PAN (e.g., the payment account) to be tokenized and creates an association mapping between the token and the PAN. The TASS 28 stores the token-to-PAN mapping data (e.g., in a data mapping table) in a database, such as a database 26. The TASS 28 transmits the token to the POS terminal 32 such that the token can be used in a payment authorization request. However, upon receipt of a rejection response from the consumer 22, the TASS 28 automatically declines the transaction. This process is generally the same whether being performed at a POS terminal 32, the consumer computing device 204, an ATM, or any other suitable transaction device.

In the exemplary embodiment, using the interchange network 16, computers of the acquirer 14 or merchant processor also communicate with computers of the card issuer 18 for approved transactions to determine whether the consumer's account is in good standing and whether the purchase is covered by the consumer's available credit line. Based on these determinations, the request for authorization will be declined or accepted. If the request is accepted, an authorization code is issued to the merchant 12.

When a request for authorization is approved by the card issuer 18, the available credit line of the consumer's account is decreased. Normally, a charge for a payment card transaction is not posted immediately to the consumer's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the POS terminal 32. This may include bundling of approved transactions daily for standard retail purchases. The interchange network 16 and/or the card issuer 18 stores the transaction data, such as, and without limitation, the PAN, a type of merchant, a merchant identifier, a location where the transaction was completed, an amount of purchase, a merchant category code, a date and time of the transaction, products purchased and related descriptions or identifiers, etc., in the database 26.

After a purchase has been completed, a clearing process occurs to transfer additional transaction data related to the purchase among the parties to the transaction, such as the acquirer 14, the interchange network 16, and the card issuer 18. More specifically, during and/or after the clearing process, additional data, such as a time of purchase, a merchant name, a type of merchant, purchase information, consumer account information, a type of transaction, information regarding the purchased item and/or service, and/or other suitable information, is associated with a transaction and transmitted between the parties to the transaction as transaction data, and may be stored by any of the parties to the transaction.

After a transaction is authorized and cleared, the transaction is settled among the merchant 12, the acquirer 14, and the card issuer 18. Settlement refers to the transfer of financial data or funds among the merchant 12, the acquirer 14, and the card issuer 18 related to the transaction. Usually, transactions are captured and accumulated into a “batch,” which is settled as a group. More specifically, a transaction is typically settled between the card issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data and stored in the database 26, at the merchant 12, the acquirer 14, the payment network 16, and/or the card issuer 18. Further, transaction data, unrelated to a particular payment account, may be collected by a variety of techniques, and similarly stored in the database 26.

In some embodiments, consumers 22 involved in the transactions described herein are prompted to agree to legal terms associated with their payment accounts, for example, during enrollment in such payment accounts, etc. As such, the consumer 22 may voluntarily agree to allow the merchants 12, the card issuers 18, the interchange network 16, etc., to utilize data collected during enrollment and/or collected relating to processing the transactions, subsequently for one or more of the purposes described herein.

While only one merchant 12, acquirer 14, interchange network 16, and issuer 18 are shown in FIG. 1 (for ease of reference), it should be appreciated that a variety of other embodiments may include multiple ones of these parties in various combinations.

FIG. 2 is a simplified block diagram of an example payment card network system, such as the payment card network system 10, including a plurality of computing devices and the TASS 28. In the example embodiment, the plurality of computing devices include, for example, a processing system 202 having a server system 30, POS terminals 32 located at merchants, such as the merchant 12 (shown in FIG. 1), client systems 34 (e.g., ATMs, computers, etc.) associated with merchants, merchant banks, payment networks, and/or issuer banks (e.g., the issuer 18 (shown in FIG. 1)), and a consumer computing device 204 associated with the consumer 22 (shown in FIG. 1). In one embodiment, the payment card network system 10 implements a process for processing card tokenization requests and transmitting consumer transaction messages using the TASS 28.

More specifically, the TASS 28 is in communication with the server system 30 and may be a component of the server system 30 or a separate computing device. The TASS 28 is configured to receive authorization requests and payment card data related to a payment card, such as the payment card 24. The payment card data includes identifying information of the payment card 24, such as such as an account number (e.g., the PAN), an expiration date, a Card Security Code (CSC), and the like. The payment card data is stored in a memory device and/or database, such as the database 26. In one embodiment, the payment card data is received from one or more sources including, for example, a POS terminal 32, a client system 34, a consumer computing device 204, and the like.

The TASS 28 includes at least one processor (not shown) in communication with the database 26 via, for example, the server system 30, which is integral to and/or associated with a payment or interchange network 16. The database 26 contains information on a variety of matters, including, for example, primary account numbers (PANs) associated with a transaction alert service for one or more users, stored transaction notification data for one or more users, one or more user profiles, tokenization data corresponding to the payment card 24, and other information described herein. In one embodiment, the database 26 is stored remotely from the TASS 28 and may be non-centralized. In an alternative embodiment, the database 26 is stored on the TASS 28.

In the exemplary embodiment, as described above, the processing system 202 includes the server system 30 of, for example, the interchange network 16 (shown in FIG. 1), coupled in communication with the TASS 28, the POS terminals 32, the client systems 34 (also includes client sub-systems), and the consumer computing device 204. In one embodiment, the client systems 34 and the consumer computing device 204 are computers that include a web browser, such that the TASS 28 is accessible to the client systems 34 and the consumer computing device 204 using the Internet. The client systems 34 and the consumer computing device 204 are interconnected to the Internet through any one or more of many interfaces including, for example, a network, such as a LAN or WAN, dial-in-connections, cable modems, and/or special high-speed Integrated Services Digital Network (ISDN) lines. The client systems 34 and consumer computing device 204 could be any device capable of interconnecting to the Internet, including a mobile computing device, an Internet connected phone, a PDA, or any other suitable web-based connectable equipment. It should be understood that the system 10 may include any number of consumer computer devices 204, client system 34, and POS terminals 32.

The TASS 28 is configured to communicate with at least the consumer computing device 204 associated with the consumer 22 (shown in FIG. 1). The consumer computing device 204 is configured to receive and present to the consumer 22 a transaction alert message received from the TASS 28. In addition, the consumer computing device 204 is configured to transmit user profile data to the TASS 28 for storing in a user profile. The TASS 28 stores the user profile associated with the consumer 22, for example, in the database 26. The user profile includes consumer contact and payment account data for the consumer 22. Additionally, the user profile may be viewed, accessed, and/or updated by the consumer computing device 204. The consumer 22 accesses the TASS 28 to enroll in the transaction alert service.

In the example embodiment, the TASS 28 receives user profile data from the consumer 22 via, for example, the consumer computing device 204. The user profile data relates to a consumer's contact information, account information, and/or transaction alert data. The user profile data is stored by the TASS 28 in the database 26. In addition, the TASS 28 receives the consumer's real-time transaction data from, for example, the interchange network 16 and/or the acquirer 14. For a given transaction, the TASS 28 identifies any consumer selected transaction alert prompt entries for the consumer's account from the user profile data. If there are no consumer selected transaction alert prompt entries stored for the consumer's account, then no further transaction processing is performed by the TASS 28 and the transaction is processed business-as-usual (BAU) by the interchange network 16. If the consumer's account has consumer selected transaction alert prompt entries, the TASS 28 transmits a notification (e.g., a transaction alert message) to the consumer 22, for example, via the consumer computing device 204.

Furthermore, the TASS 28 is configured to communicate with one or more of the POS terminals 32 and/or the client systems 34 to transmit tokenization requests and payment tokens among the systems. If the consumer's account has consumer selected transaction alert prompt entries, the TASS 28 transmits a tokenization request to the card issuer 18 upon receiving approval of the transaction from the consumer 22. If tokenization is authorized, the TASS 28 generates a payment token and transmits it back to the POS terminal 32 in which the transaction originated. The POS terminal 32 may then send a payment transaction authorization request using the payment token.

In the exemplary embodiment, the POS terminals 32 may be connected to the client systems 34 or may be connected to the server system 30. The POS terminals 32 may be interconnected to the Internet (or any other network that allows the POS terminals 32 to communicate as described herein) through any one or more of many possible interfaces including a network, such as a local area network (LAN) or a wide area network (WAN), dial-in-connections, cable modems, wireless modems, and special high-speed ISDN lines. The POS terminals 32 are any device capable of interconnecting to the Internet and including an input device capable of reading information from a consumer's financial payment card. In some embodiments, the POS terminal 32 may be a consumer's personal computer, such as when conducting an online purchase through the Internet. As used herein, the terms POS device, POS terminal, and point of interaction device are used broadly, generally, and interchangeably to refer to any device in which the consumer 22 interacts with to complete a payment card transaction, such as a tokenization request.

A database server 36 is connected to the database 26. In one embodiment, the database 26 is a centralized database stored on the server system 30. The database 26 may be accessed by potential users at one of the client systems 34 by logging onto the server system 30 through one of the client systems 34. In an alternative embodiment, the database 26 is stored remotely from the server system 30 and may be a distributed or non-centralized database.

In one example embodiment, the database 26 may include a single database having separated sections or partitions or may include multiple databases, each being separate from each other. The database 26 stores a user profile, as described above, and may store transaction data generated as part of sales activities conducted over the processing network, including data relating to merchants, account holders or customers, issuers, acquirers, savings amounts, savings account information, and/or purchases made. The database 26 may also store account data including at least one of a consumer name, a consumer address, an account number, and other account identifiers that relate the payment card 24 to the consumer, such as the consumer 22. The database 26 may also store merchant data including a merchant identifier that identifies each merchant registered to use the network, and instructions for performing and settling transactions, including merchant bank account information. The database 26 may also store authorization request data and tokenization request data.

In the exemplary embodiment, one of the client systems 34 may be associated with the acquirer 14 (shown in FIG. 1) while another one of the client systems 34 may be associated with the issuer 18 (shown in FIG. 1). The POS terminal 32 may be associated with the merchant 12 (shown in FIG. 1) or may be a computer system and/or mobile computing system used by a cardholder (e.g., the consumer 22(shown in FIG. 1)) making an on-line purchase or payment. The server system 30 may be associated with the interchange network 16 or another payment processor. In the example embodiment, the server system 30 is associated with a financial transaction processing network, such as the interchange network 16, and may be referred to as an interchange computer system. The server system 30 may be used for processing tokenization and transaction data. In addition, the client systems 34 and the POS terminals 32 may include a computer system associated with at least one of a merchant, an online bank, a bill payment outsourcer, an acquirer bank, an acquirer processor, an issuer bank associated with a payment card, an issuer processor, a remote payment processing system, a third-party aggregator, and/or a biller.

### Exemplary Computer Systems

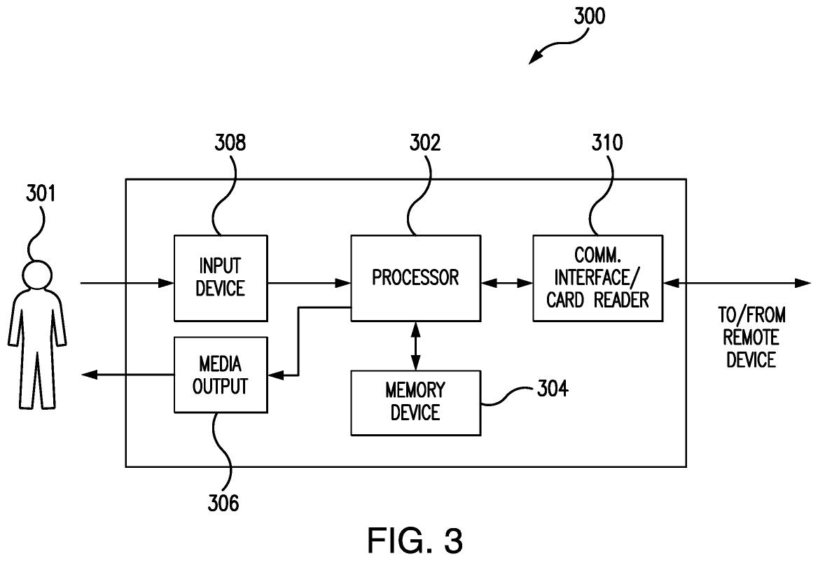

FIG. 3 is an example configuration of a user system 300 operated by a user 301, such as the consumer 22 (shown in FIG. 1). In some embodiments, the user system 300 is a consumer computing device 204, a POS terminal 32, and/or a client system 34 (each shown in FIG. 2).

In the example embodiment, the user system 300 includes one or more processors 302 for executing instructions. In some embodiments, executable instructions are stored in a memory device 304. The processor 302 may include one or more processing units arranged, for example, in a multi-core configuration. The memory device 304 is any device allowing information such as digital wallet data (optional), executable instructions, and/or written works to be stored and retrieved. The memory device 304 includes one or more computer readable media.

In one example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

A location of the user system 300 can be obtained through conventional methods, such as a location service (e.g., global positioning system (GPS) service) in the user system 300, “ping” data that includes geotemporal data, from cell location register information held by a telecommunications provider to which the user system 300 is connected, and the like. For example, in some embodiments, the user system 300 may include an optional GPS chip (not shown), which can be part of or separate from the processor 302 to enable the location of the user system 300 to be determined.

The user system 300 also includes at least one media output component 306 for presenting information to the user 301. The media output component 306 is any component capable of conveying information to the user 301. In some embodiments, the media output component 306 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In one example embodiment, the media output component 306 includes an integrated display, which can include, for example, and without limitation, a liquid crystal display (LCD), an organic light emitting diode (OLED) display, or an “electronic ink” display. In some embodiments, the integrated display may optionally include a touch controller for support of touch capability. In such embodiments, the user system 300 may detect a person's presence by detecting that the person has touched the integrated display on the user system 300.

In some embodiments, the user system 300 includes an input device 308 for receiving input from the user 301. The input device 308 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 306 and the input device 308, as described above. The user system 300 may also include a transceiver 310 (broadly, a communication interface), which is communicatively connectable to a remote device such as a client system 34 (shown in FIG. 2). The transceiver 310 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 306 and, optionally, receiving and processing input from the input device 308. A user interface may include, among other possibilities, a web browser and/or an application. Web browsers enable users, such as the consumer 22, to display and interact with media and other information typically embedded on a web page or a website from the TASS 28. An application may allow the consumer 22 to interact with the TASS 28 to register selected transaction alert prompt entries for generating notifications.

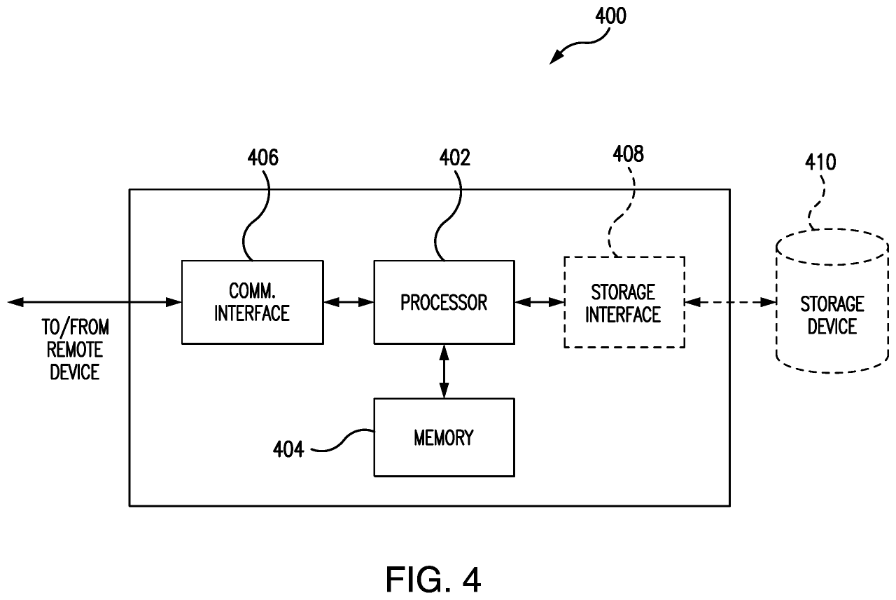

FIG. 4 is an example configuration of a server system 400, such as the TASS 28 (shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

In one example embodiment, the processor 402 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

The processor 402 is operatively coupled to a communication interface 406 such that the server system 400 can communicate with a remote device such as a user system 300 or another server system. For example, the communication interface 406 may receive communications from the consumer computing device 204 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400 and is like the database 26 (shown in FIG. 1). In other embodiments, the storage device 410 is external to the server system 400. For example, the server system 400 may include one or more hard disk drives as the storage device 410. In other embodiments, the storage device 410 is external to the server system 400 and may be accessed by a plurality of server systems. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Exemplary Computer-Implemented Methods

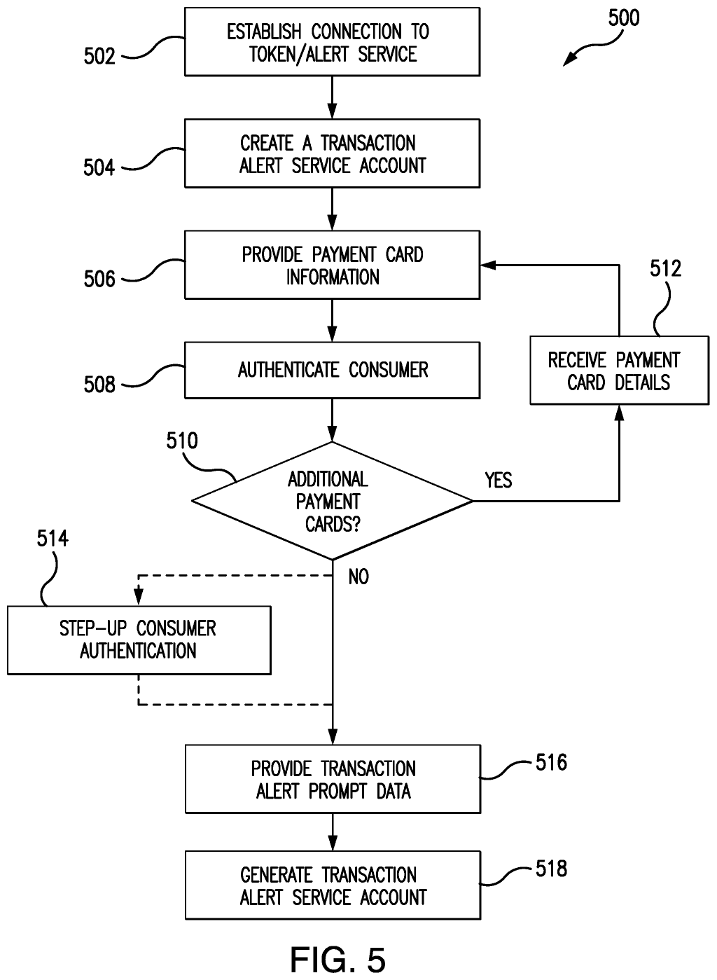

FIG. 5 is a flowchart illustrating an exemplary computer-implemented method 500 for registering a consumer for a transaction alert service, in accordance with one embodiment of the present disclosure. The operations described herein may be performed in the order shown in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 500 is described below, for ease of reference, as being executed by exemplary devices and components introduced with the embodiments illustrated in FIGS. 1-4. In one embodiment, the computer-implemented method 500 is implemented by the TASS 28 (shown in FIG. 1). In the exemplary embodiment, the computer-implemented method 500 relates to receiving consumer registration information from the consumer computing device 204 (shown in FIG. 2) upon registration for the transaction alert service. While operations within the computer-implemented method 500 are described below regarding the consumer computing device 204, according to some aspects of the present invention, the computer-implemented method 500 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The consumer 22 must be registered for the transaction alert service to receive notifications associated with a transaction corresponding to one or more of the consumer's accounts. Referring to operation 502, in the example embodiment, the consumer 22 connects to the TASS 28 via the interchange network 16, e.g., via a webservice providing transaction alert service registration via use of a web browser. Alternatively, the consumer 22 may access the TASS 28 via an application configured for direct connection to the TASS 28. In such instances, the application may be stored in a cloud-based interface, which may include cloud storage capability as well as any cloud-based API that facilitates communication between the consumer computing device 204 and TASS 28.

At operation 504, the consumer 22 is presented an option to create a transaction alert service account. For example, the consumer 22 registers or enrolls for the transaction alert service via a suitable webpage of the TASS 28 using, for example, the consumer computing device 204. It should be understood that the consumer 22 may enroll or register with the transaction alert service in any of several ways, including utilizing the consumer computing device 204 to access the TASS 28 via the Internet and providing the requisite information. During consumer enrollment, the consumer 22 may provide enrollment data including basic information about himself or herself (e.g., name, address, phone number, etc.) and, in some embodiments, provide information regarding the consumer's computing device (for example, by providing a SIM identifier and/or a mobile telephone number and/or other computing device identifier). It is noted that the transaction alert service account can be linked to other Mastercard services if the consumer 22 is already signed up for other unrelated services. In some embodiments, the information obtained from the consumer 22 during the enrollment process includes product and/or service preferences, requirements data, and/or other information.

At operation 506, the consumer 22 provides information concerning his or her payment card, e.g., a bank credit card primary account number, debit card primary account number, loyalty card primary account number, gift card primary account number, and the like issued to or held by him or her. At operation 508, the TASS 28 authenticates the consumer 22. For example, and without limitation, the consumer 22 may be asked to input a string of characters indicating a code printed on the signature panel of the consumer's payment card. The signature panel code may be, for example, a card verification code (CVC) value. The values entered by the consumer 22 may be used by the TASS 28 to authenticate the consumer 22 prior to setting up the transaction alert service account and associating the consumer 22 and the consumer's payment card with the account. For example, the TASS 28 compares the entered values to the values associated with the payment card stored in a database (e.g., the database 26 shown in FIG. 1). If the entered values match the stored values, the consumer 22 is authenticated.

Alternatively, the TASS 28 may authenticate the consumer 22 via a one-time code sent to the consumer 22 via, for example, Short Message Service (SMS), e-mail, through a call center communication, and the like. Optionally, the method 500 may include an additional operation for authenticating the consumer 22 offline. For example, and without limitation, the TASS 28 may provide an offline PIN to the consumer 22 via mail.

At operation 510, the TASS 28 asks the consumer 22 whether the consumer has additional payment cards he or she wishes to associate with the consumer's transaction alert service account. If the consumer has additional payment cards to enter, at operation 512, the TASS 28 receives the payment card details from the consumer 22 and returns to operation 506. If the consumer does not have any additional payment cards to enter, the method continues to optional operation 514 or operation 516.

At optional operation 514, the TASS 28 requests that the consumer 22 set up a step-up authentication method, i.e., two-factor authentication. The additional authentication measures may be taken before the transaction alert prompts may be entered into the transaction alert service by the consumer 22. For example, and without limitation, in one embodiment, the consumer 22 is requested to establish account access credentials, e.g., to select a username and password or PIN (personal identification number) to be used for security purposes, and/or for use by the consumer 22 to login and change one or more preference and/or notification settings. In addition to the password or PIN, the consumer 22 may be requested to set up a second authentication factor, including, for example, and without limitation, providing a biometric sample that is to be associated with the other registration information provided.

Biometric samples include, without limitation, a fingerprint image, a voice recording, a retinal image, facial recognition, palm print image, iris recognition, and the like. The biometric sample is unique to the consumer 22 and difficult to duplicate and/or forge by an unauthorized user. The biometric sample may be stored and associated with a biometric identifier, for example, by the TASS 28 (e.g., in the database 134, etc.). Additionally, the biometric identifier may be associated with the stored registration information and facilitates secure authorization of requested notification data input by the consumer 22. A biometric input device in communication with the consumer computing device 204 may be used for the consumer 22 to enter the biometric sample. For example, the consumer computing device 204 may include an integral fingerprint or palm reader/scanner, retinal or iris reader/scanner, and/or voice reader/recorder.

In other suitable embodiments, the second factor may include, for example, and without limitation, SMS two-factor authentication (where a one-time use short code is sent to the consumer's mobile device via SMS), Time-Based One Time Password (TOTP) authentication (where an authenticator application provides a short code as a second factor), push-based two-factor authentication (where a prompt is sent to the consumer's mobile device), or any other two-factor authentication method that enables the method 500 to operate as described herein.

At operation 516, the TASS 28 requests that the consumer 22 setup transaction alert prompt data (or transaction alert prompt entries) used by the transaction alert service to generate transaction alert messages for the consumer. For example, and without limitation, the consumer 22 may select to receive transaction alert messages for any one or more of the consumer's registered accounts. In one embodiment, the consumer 22 may be presented with a list of his or her registered accounts. As such, for each registered account, the consumer 22 may be presented with an option to select to receive transaction alert messages associated with that account, for example, by selecting or clicking a checkbox. The selections may then be saved, for example, as part of the transaction alert data of the transaction alert service account for the consumer 22 in the database 26.

At operation 518, the TASS 28 generates the transaction alert service account for the consumer 22, associating the consumer's one or more payment cards with the account along with the consumer's account access credentials and transaction alert data, and stores the transaction alert service account in a database, e.g., the database 26.

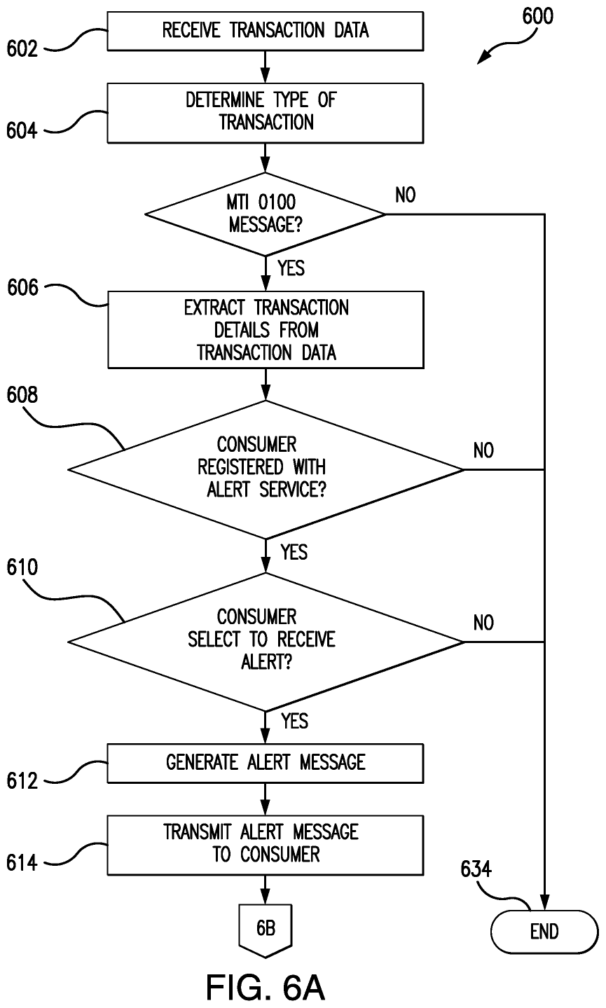

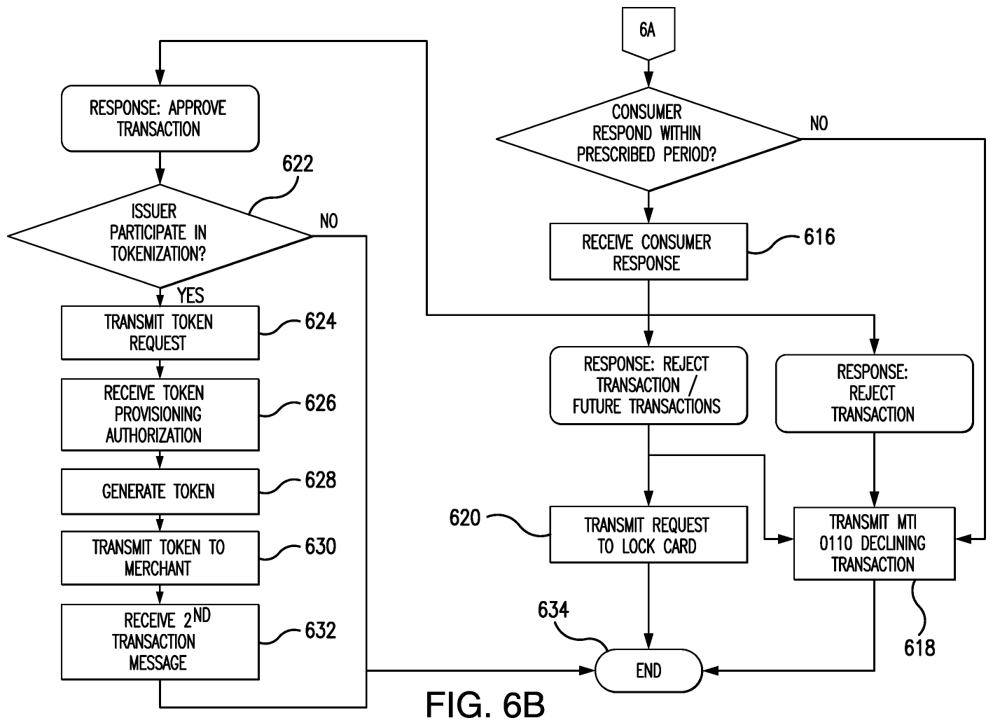

FIGS. 6A and 6B cooperatively depict a flowchart illustrating an exemplary computer-implemented method 600 for generating a transaction alert message and tokenizing a payment card transaction using the TASS 28 (shown in FIGS. 1 and 2), in accordance with one embodiment of the present disclosure. The operations described herein may be performed in the order shown in FIGS. 6A and 6B or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the TASS 28. In the exemplary embodiment, the computer-implemented method 600 relates to receiving transaction data from the interchange network 16, generating a transaction alert message for the consumer 22, and provisioning a token for the transaction. While operations within the computer-implemented method 600 are described below regarding the TASS 28, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, the TASS 28 receives an electronic transaction message including consumer transaction data from a merchant, such as the merchant 12 (shown in FIG. 1), via the interchange network 16. As used herein, the term “electronic transaction message” includes specially-formatted data describing events, requests, and replies. In general, electronic messaging includes the creation, storage, exchange, and management of text, images, voice, telex, fax, e-mail, paging, and Electronic Data Interchange (EDI) over a communications network, such as the network 20 (shown in FIG. 1).

In the exemplary embodiment, the consumer transaction data may correspond to a payment card account associated with the consumer's transaction alert service account. For example, and without limitation, the consumer transaction data may be included in an electronic transaction message such as may be received from a card issuer or a merchant point-of-sale device (e.g., directly or as transmitted via one or more intermediate entities). Typical electronic transaction messages may be formatted pursuant to one or more standards, such as the International Organization of Standardization ISO 8583 standard, and may include a plurality of data elements, where each data element may be configured to store payment and transaction data as set forth in the associated standards. The data elements may include, for example, a data element configured to store a PAN, a data element configured to store a transaction type, a data element configured to store a transaction amount, a data element configured to store a transaction time, etc. The electronic transaction messages may also include a message type indicator, which may be indicative of a type of the electronic transaction message, such as an authorization request, authorization response, etc. In some instances, an electronic transaction message may also include a bitmap, which may indicate the data elements included in the electronic transaction message and the data stored therein.

At operation 604, the TASS 28 determines the type of electronic transaction message. In the exemplary embodiment, the electronic transaction message may include several transaction types, including a debit transaction, a credit transaction, a reversal transaction, a chargeback transaction, and/or a message declining a transaction due to suspected fraud. An electronic debit transaction may include, for example, a financial transaction request message (e.g., a message type indicator (MTI) 0100 authorization request message) requesting authorization for performing a purchase transaction. If a transaction is terminated, for example, after a pre-authorization, the electronic transaction message may be a reversal message (e.g., an MTI 0400 message). Furthermore, an electronic first chargeback transaction message may include, for example, an MTI 1442 message having a function code of 450 for the full amount of the transaction, or an MTI 1442 message having a function code of 453 for a partial amount of the transaction. It is noted that each of the electronic transaction messages may include a transaction amount, as is described herein.

In the exemplary embodiment, if the electronic transaction message is an MTI 0100 message, the method continues to operation 606. Otherwise, the method 600 ends at operation 634 and the transaction is processed BAU by the interchange network 16.

At operation 606, the TASS 28 extracts transaction details from the electronic transaction message, and more particularly, from the transaction data received, for example, from the merchant 12 or acquirer 14. Specifically, the TASS 28 extracts a copy of the PAN from the transaction details of the electronic transaction message and temporarily stores it in memory, such as memory 404 (shown in FIG. 4).

At operation 608, the TASS 28 determines whether the consumer 22 is registered for the transaction alert service. Specifically, the TASS 28 retrieves the transaction alert service accounts from the database 26 and attempts to match the extracted PAN to a payment card associated with a consumer's respective transaction alert service account. The TASS 28 maintains a list of PANs associated with the consumers 22 who are registered with the transaction alert service. The PANs are stored in the transaction alert service account for the consumer 22 on the database 26. If there is no match, the process ends at operation 634 and the transaction is processed BAU by the interchange network 16.

If there is a match based on the comparison of the extracted PAN to the list of PANs associated with the transaction alert service accounts, at operation 610, the TASS 28 determines whether the consumer selected to receive a transaction alert message corresponding to the extracted PAN. As described herein, the consumer 22 may register one or more accounts (e.g., PANs) and select to receive transaction alert messages of transactions associated with certain user-selected accounts. In one suitable example, the TASS 28 analyzes the transaction alert data stored in the transaction alert service account for the consumer 22 to confirm whether the transaction alert data indicates that the consumer 22 selected to receive a transaction alert message for the identified account. If the consumer 22 did not select to receive a transaction alert message, the process ends at operation 634 and the transaction is processed BAU by the interchange network 16.

At operation 612, if the consumer 22 selected to receive a transaction alert message corresponding to the identified account, the TASS 28 generates a corresponding transaction alert message of the transaction. In the exemplary embodiment, the transaction alert message may be generated in real time or near real time. As used herein, the term “real time” includes the time of occurrence of the associated events, the time to process data, and/or the time of a system response to the events and the environment. In the embodiments described herein, these activities and events occur substantially instantaneously.

In the exemplary embodiment, the transaction alert message may contain information specific to the transaction. For example, the electronic transaction message may contain various transaction information, including, without limitation, a name of the merchant 12, a location of the merchant 12, a date of the transaction, and an amount of the transaction. This information may be used by the TASS 28 to generate the transaction alert message.

The transaction alert messages are generated in a format that can be received by and presented to the consumer 22, for example, on the consumer computing device 204. The transaction alert message sent to a mobile device may be in a particular format and may conform to requirements defined by a mobile network operator. For example, and without limitation, a mobile network operator may specify that an SMS message has limitations on a number of characters and/or a pre-determined memory size (e.g., bits, bytes, etc.).

The transaction alert message also includes a request to the consumer 22 to respond to the transaction alert message with one of several responses. For example, in a preferred embodiment, the transaction alert message includes a request to the consumer to approve the transaction, reject the transaction, or reject the transaction and lock the payment card against further transactions. In this manner, the consumer 22 can approve or reject individual transactions or reject this indicated transaction and all future transactions associated with the identified account.

At operation 614, the TASS 28 transmits the transaction alert message to the consumer 22. In particular, the TASS 28 transmits the transaction alert message to the consumer computing device 204 (e.g., a device identified by the mobile device identifier described herein) via a preferred method of delivery selected by the consumer 22 and stored as part of the transaction alert data stored in the transaction alert service account for the consumer 22. In some embodiments, the preferred method of delivery may include, for example, and without limitation, the form of a push notification, an interactive voice response (IVR), an instant message (IM), an SMS message, an email message, a web-based application message (e.g., via a digital wallet payment application, etc.), or any other suitable message form transmitted, in this example, to the consumer computing device 204. It should be understood that other transaction alert message content and/or a different delivery method may be defined by the consumer in the transaction alert service data stored in the transaction alert service account. In certain embodiments, if the consumer does not respond within a predetermined period (e.g., thirty (30) seconds, one (1) minute, etc.), at operation 618, the TASS 28 automatically declines the transaction. For example, the TASS 28 transmits an MTI 0110 authorization request response message to the POS terminal 32 indicating that the transaction is declined, and the method ends at operation 634.

If the consumer 22 responds within the predetermined period, at operation 616, the TASS 28 receives a response to the transaction alert message from the consumer 22. For example, and without limitation, the consumer 22 transmits a response to the transaction alert message via the consumer computing device 204. At operation 618, if the response is to reject the transaction, the TASS 28 transmits an MTI 0110 authorization request response message to the POS terminal 32 indicating that the transaction is declined. If the response is to reject the transaction and all future transactions, the TASS 28 transmits an MTI 0110 authorization request response message to the POS terminal 32 indicating that the transaction is declined (operation 618) and, at operation 620, transmits a request message to the card issuer 18 to lock the payment card, such as the payment card 24, against future transactions. Furthermore, in some embodiments, the TASS 28 may store an indicator in the user profile associated with the identified account that the account is blocked from future transactions. The method 600 then ends at operation 634.

At operation 622, if the response is to approve the transaction, the TASS 28 determines whether the card issuer 18 of the payment card 24 participates in tokenization and, if so, at operation 624 transmits a token request message to the card issuer 18, which, in the example embodiment, allows or denies the token creation process to proceed. If the token creation process is allowed to proceed, the card issuer 18 initiates token creation. If the card issuer 18 does not participates in tokenization, the operation ends at operation 634.

It should be noted that in some suitable embodiments, the TASS 28 may employ machine learning techniques to detect out-of-pattern transactions performed using the payment card 24. As such, the TASS 28 can automatically approve transactions that appear to be normal for the consumer 22 and only request a response from the consumer 22 for those transactions that appear to be out-of-pattern. Thus, for out-of-pattern transactions, the TASS 28 may require a consumer's response to approve such as transaction. Detection of out-of-pattern transactions can be accomplished using a number of known machine learning techniques using a consumer historical transaction data.

Referring back to FIG. 6B, at operation 626, the card issuer 18 transmits a token provisioning authorization message to the TASS 28. At operation 628, the TASS 28 creates a token and transmits the token to the merchant 12 (e.g., to the merchant POS terminal 32). The TASS 28 stores the token and the PAN associated with the token in a database, such as the database 26, for use in completing the payment transaction. At operation 630, the merchant 12 receives the token and, at operation 632, transmits a second electronic transaction message, and in particular, an MTI 0100 authorization request message using the token received from the TASS 28. For example, the merchant 12 transmits the MTI 0100 authorization request message to the acquirer 14, which passes the authorization request to the interchange network 16. The authorization request message includes the token in the place of the PAN. The acquirer 14 or interchange network 16 uses the token to query the database 26 of the TASS 28 to retrieve the PAN associated with the token. In the example embodiment, the interchange network 16 transmits the PAN to the card issuer 18 with the authorization request and the card issuer 18 determines whether to authorize the transaction. The method ends at operation 634.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A computer-implemented method comprising:
receiving an electronic transaction message from a merchant, the electronic transaction message corresponding to a transaction associated with a primary account number of a payment card of a consumer;
determining whether the electronic transaction message is an authorization request message;
based on a determination that the electronic transaction message is an authorization request message, extracting the primary account number from the electronic transaction message;
transmitting a transaction alert message to the consumer, the transaction alert message including a request that the consumer respond to the transaction alert message approving or rejecting the transaction;
receiving a response to the transaction alert message from the consumer;
if the response is approving the transaction, transmitting a token request message to a card issuer associated with the payment card;
generating a token for the primary account number;
transmitting the token to the merchant; and
receiving from the merchant, a second authorization request message for the transaction, the second authorization request message including the token.

2. The computer-implemented method in accordance with claim 1, further comprising:
determining whether the consumer is registered for a transaction alert service; and
based on determining that the consumer is registered, determining whether the consumer selected to receive the transaction alert message.

3. The computer-implemented method in accordance with claim 2,
said operation of determining whether the consumer selected to receive the transaction alert message includes the operations of:
retrieving a transaction alert service account for the consumer from a database; and
analyzing transaction alert data stored in the transaction alert service account to determine whether the transaction alert data indicates that the consumer selected to receive the transaction alert message corresponding to the extracted primary account number.

4. The computer-implemented method in accordance with claim 3, further comprising comparing the extracted primary account number to the transaction alert data stored in the transaction alert service account.

5. The computer-implemented method in accordance with claim 1, further comprising:
generating the transaction alert message,
said generating operation comprising formatting the transaction alert message in a format that can be received by a consumer computing device.

6. The computer-implemented method in accordance with claim 5,
said operation of transmitting a transaction alert message to the consumer comprising transmitting the transaction alert message to the consumer computing device using a preferred method of delivery selected by the consumer.

7. The computer-implemented method in accordance with claim 6,
the preferred method of delivery including one or more of the following: a push notification, an interactive voice response, an instant message, a short message service message, an email message, and a web-based application message.

8. The computer-implemented method in accordance with claim 1, the request that the consumer respond to the transaction alert message comprising at least the following: a request to the consumer to approve the transaction, a request to the consumer to reject the transaction, and a request to the consumer to reject the transaction and lock the payment card against further transactions.

9. The computer-implemented method in accordance with claim 1, further comprising determining whether the card issuer of the payment card allows for tokenizing the primary account number.

10. The computer-implemented method in accordance with claim 1, further comprising receiving, from the card issuer of the payment card, a token provisioning authorization message.

11. The computer-implemented method in accordance with claim 1, further comprising storing, in a database, the token and the associated primary account number.

12. A token/alert service system comprising:
a database; and
a server comprising a processor coupled to said database, said processor programmed to:
receive an electronic transaction message from a merchant, the electronic transaction message corresponding to a transaction associated with a primary account number of a payment card of a consumer;
determine whether the electronic transaction message is an authorization request message;
based on a determination that the electronic transaction message is an authorization request message, extract the primary account number from the electronic transaction message;
transmit a transaction alert message to the consumer, the transaction alert message including a request that the consumer respond to the transaction alert message approving or rejecting the transaction;
receive a response to the transaction alert message from the consumer;
if the response approves the transaction, transmit a token request message to a card issuer associated with the payment card;
generate a token for the primary account number;
transmit the token to the merchant; and
receive from the merchant, a second authorization request message for the transaction, the second authorization request message including the token.

13. The system in accordance with claim 12,
said processor further programed to:
determine whether the consumer is registered for a transaction alert service; and
based on determining that the consumer is registered, determine whether the consumer selected to receive the transaction alert message.

14. The system in accordance with claim 13,
said processor being further programmed, as part of determining whether the consumer selected to receive the transaction alert message, to:
retrieve a transaction alert service account for the consumer from said database; and
analyze transaction alert data stored in the transaction alert service account to determine whether the transaction alert data indicates that the consumer selected to receive the transaction alert message corresponding to the extracted primary account number.

15. The system in accordance with claim 14,
said processor being further programmed to compare the extracted primary account number to the transaction alert data stored in the transaction alert service account.

16. The system in accordance with claim 12,
said processor being further programmed to generate the transaction alert message, including formatting the transaction alert message in a format that can be received by a consumer computing device.

17. The system in accordance with claim 12, wherein the request that the consumer respond to the transaction alert message comprises at least the following: a request to the consumer to approve the transaction, a request to the consumer to reject the transaction, and a request to the consumer to reject the transaction and lock the payment card against further transactions.

18. The system in accordance with claim 12,
said processor being further programmed to determine whether the card issuer of the payment card allows for tokenizing the primary account number.

19. The system in accordance with claim 12,
said processor being further programmed to receive, from the card issuer of the payment card, a token provisioning authorization message.

20. The system in accordance with claim 12,
said processor being further programmed to store, in said database, the token and the associated primary account number.
